(19) United States
(12) Patent Application Publication
(10) Pub. No.: US 2016/0002377 A1
(43) Pub. Date: Jan. 7, 2016

(54) MOLD RELEASING AGENT

(71) Applicant: TAIWAN FLUORO TECHNOLOGY CO., LTD., Taichung (TW)

(72) Inventors: Jung-Wei CHANG, Changhua County (TW); Ren-Ren CHIOU, New Taipei (TW); Jih-Hsih HO, Taichung (TW)

(73) Assignee: TAIWAN FLUORO TECHNOLOGY CO., LTD., Taichung (TW)

(21) Appl. No.: 14/321,249

(22) Filed: Jul. 1, 2014

(51) Int. Cl. C08F 216/14; C09D 183/04; B29C 33/64; C09D 129/10; C09D 183/08; C09D 183/06; C08F 220/06; C09D 133/02

(52) U.S. Cl. CPC C08F 216/1408; C08F 220/06; C09D 183/04; C09D 133/02; C09D 129/10; C09D 183/08; C09D 183/06; B29C 33/64

(57) ABSTRACT

A mold releasing agent is copolymerized with a fluorine-containing monomer, an acrylic ester monomer, and an acid monomer. Whereby, the mold releasing agent has comparable releasing performance and longevity to long-chain copolymers containing halothane.

### BACKGROUND OF THE INVENTION

1. Technical Field

The present invention relates generally to mold releasing agent, and more particularly to a type of mold releasing agent which belongs to fluorine-containing copolymer.

2. Description of Related Art

Moldings made of resin or rubber are produced by filling the materials into a mold, wherein the mold is typically coated with mold releasing agent in order to get moldings out of the mold easier. Since the mold releasing agent is applied repeatedly, there would be an accumulation on the mold when the frequency of use increases. As a result, the fineness of the moldings would be affected, and it would even pollute the environment.

The conventional mold releasing agent is a kind of fluoride which is mainly chemical compounds of perfluoroalkyl chains with eight or more carbon atoms. However, according to recent studies, long-chain perfluoroalkyl compounds may be degraded to perfluorocaprylic acid (PFOA) in certain conditions, and PFOA tends to accumulate in vivo. Therefore, the conventional kind of fluoride is gradually replaced by that of short-chain perfluoroalkyl, which has lower environmental persistence.

### BRIEF SUMMARY OF THE INVENTION

In view of the above, the primary objective of the present invention is to provide a mold releasing agent, which has comparable releasing performance and longevity to long-chain copolymers containing halothane.

The mold releasing agent provided in the present invention includes a fluorine-containing monomer, an acrylic ester monomer, and an acid monomer.

In an embodiment, the fluorine-containing monomer is represented by the general expression CH_{2═}C(—X)C(═O)—Y—Z—R_{f}, where X is hydrogen atom, monovalent organic group, halogen atoms, linear or branched perfluoroalkyl with 1 to 21 carbon atoms, or cyano; Y is oxygen atom, sulfur atom, or secondary amine; Z is straight chain alkane, divalent organic group, aromatics or Cycloaliphatic of which carbon-number is 6 to 18, or aliphatic groups of which carbon-number is 1 to 10; R_{f} is linear or branched perfluoroalkyl of which carbon-number is 1 to 21.

In an embodiment, the acrylic ester monomer is presented by the general expression CH_{2═}CA₁COOA₂, where A₁ is hydrogen atom, methyl, or halogen atoms other than fluorine atom; A₂ is CₙH₂ₙ₊₁ alkyl, wherein n is between 1 and 30.

In an embodiment, the acrylic ester monomer is selected from the group consisting of

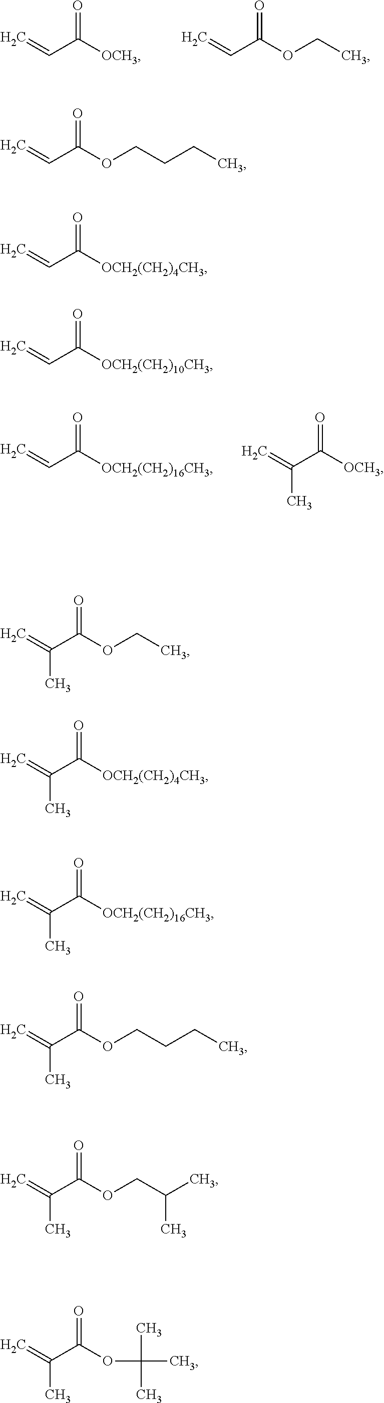

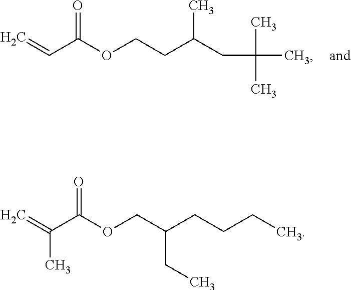

In an embodiment, the molding releasing agent further includes silicon oil.

In an embodiment, the silicon oil is selected from the group consisting of dimethyl silicone oil, methyl chloride silicon oil, methylphenyl silicone oil, and organic denatured silicone oil.

In an embodiment, the silicon oil is selected from the group consisting of

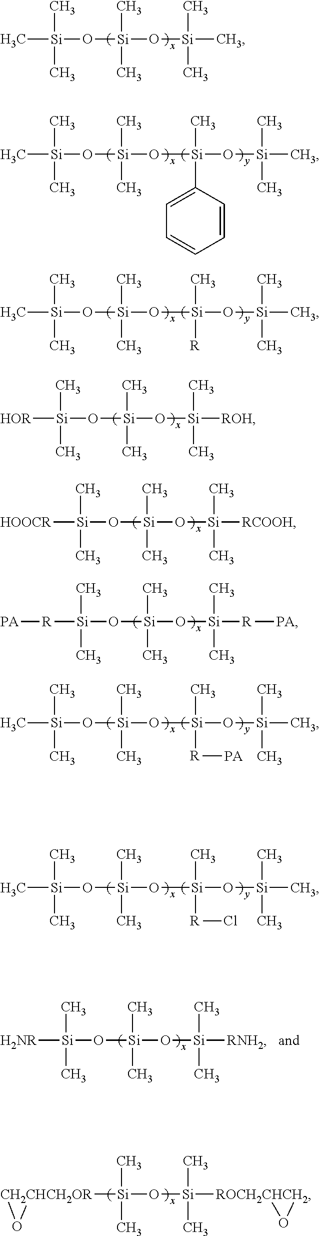

where R is alkylidene radical which has one or more carbon atoms; PA is Polyoxyalkylene; x and y are integers, which are one or more.

In an embodiment, the acid monomer is selected from at least one member of the group consisting of carboxylic acid, phosphate group, phosphonic acid group, phosphinic acid group, sulfate, sulfo group, and sulfino.

In an embodiment, further includes Azobisisobutyronitrile or azobisisobutyronitrile HEPTANITRILE.

In an embodiment, the mold releasing agent is solvent-copolymer.

In an embodiment, a solid content of the mold releasing agent is 1% by weight.

### BRIEF DESCRIPTION OF THE SEVERAL VIEWS OF THE DRAWINGS

None.

### DETAILED DESCRIPTION OF THE INVENTION

A preferred embodiment of the present invention is applied to synthesize a mold releasing agent of fluorine-containing copolymer, wherein the mold releasing agent is copolymerized with the following components: (A) fluorine-containing monomer, (B) acrylic ester monomer, and (C) acid monomer. The fluorine-containing copolymer can be classified as water based copolymer or solvent-copolymer according to its reaction results.

In more details, (A) fluorine-containing monomer is represented by the general expression CH_{2═}C(—X)C(═O)—Y—Z—R_{f}, where

X is hydrogen atom, monovalent organic group, halogen atoms, linear or branched perfluoroalkyl with 1 to 21 carbon atoms, or cyano; Y is oxygen atom, sulfur atom, or secondary amine; Z is straight chain alkane, divalent organic group, aromatics or Cycloaliphatic of which carbon-number is 6 to 18, or aliphatic groups of which carbon-number is 1 to 10; R_{f} is linear or branched perfluoroalkyl of which carbon-number is 1 to 21. Here are some examples of R_{f} listed below, but please be noted that they are not limitations of the present invention:

H₂C═CH—C(═O)—O(CH₂)₂—(CF₂)₅CF₃

H₂C═CH—C(═O)—O(CH₂)₂—(CF₂)₇CF₃

H₂C═CH—C(═O)—O(CH₂)₂—(CF₂)₉CF₃

H₂C═CH—C(═O)—O(CH₂)₂—(CF₂)₂—CF—(CF₃)₂

H₂C═CH—C(═O)—O(CH₂)₂—(CF₂)₄—CF—(CF₃)₂

H₂C═C(CH₃)—C(═O)—O(CH₂)₂—(CF₂)₅CF₃

H₂C═C(CH₃)—C(═O)—O(CH₂)₂—(CF₂)₇CF₃

H₂C═C(CH₃)—C(═O)—O(CH₂)₂—(CF₂)₉CF₃

H₂C═C(CH₃)—C(═O)—O(CH₂)₂—(CF₂)₂—CF—(CF₃)₂

H₂C═C(CH₃)—C(═O)—O(CH₂)₂—(CF₂)₄—CF—(CF₃)₂

H₂C═CH—C(═O)—S(CH₂)₂—(CF₂)₅CF₃

H₂C═CH—C(═O)—S(CH₂)₂—(CF₂)₇CF₃

H₂C═CH—C(═O)—S(CH₂)₂—(CF₂)₂—CF—(CF₃)₂

H₂C═CH—C(═O)—S(CH₂)₂—(CF₂)₄—CF—(CF₃)₂

H₂C═C(CH₃)—C(═O)—S(CH₂)₂—(CF₂)₅CF₃

H₂C═C(CH₃)—C(═O)—S(CH₂)₂—(CF₂)₇CF₃

H₂C═C(CH₃)—C(═O)—S(CH₂)₂—CF₂)₂—CF—(CF₃)₂

H₂C═C(CH₃)—C(═O)—S(CH₂)₂—CF₂)₄—CF—(CF₃)₂

H₂C═CH—C(═O)—NH(CH₂)₂—(CF₂)₅CF₃

H₂C═CH—C(═O)—NH(CH₂)₂—(CF₂)₇CF₃

H₂C═CH—C(═O)—NH(CH₂)₂—(CF₂)₂—CF—(CF₃)₂

H₂C═CH—C(═O)—NH(CH₂)₂—(CF₂)₄—CF—(CF₃)₂

H₂C═C(CH₃)—C(═O)—NH(CH₂)₂—(CF₂)₅CF₃

H₂C═C(CH₃)—C(═O)—NH(CH₂)₂—(CF₂)₇CF₃

H₂C═C(CH₃)—C(═O)—NH(CH₂)₂—(CF₂)₂—CF—(CF₃)₂

H₂C═C(CH₃)—C(═O)—NH(CH₂)₂—(CF₂)₄—CF—(CF₃)₂

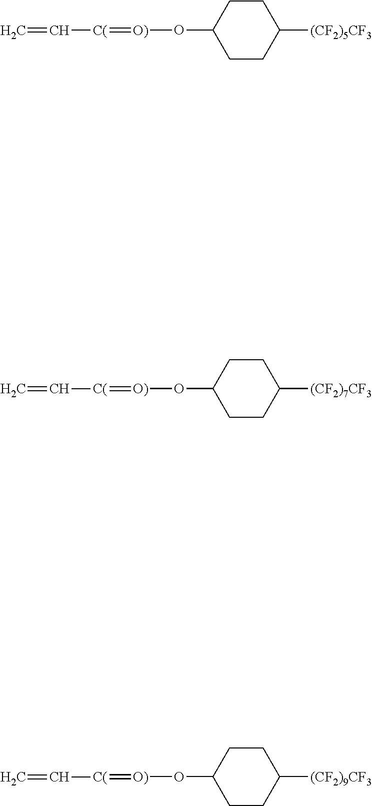

(B) acrylic ester monomer is represented by the general expression CH₂═CA₁COOA₂, where

A₁ hydrogen atom, methyl, or halogen atoms other than fluorine atom; A₂ is CₙH₂ₙ₊₁ alkyl, wherein n is between 1 and 30. Here are some examples of A₂ listed below, but please be noted that they are not limitations of the present invention:

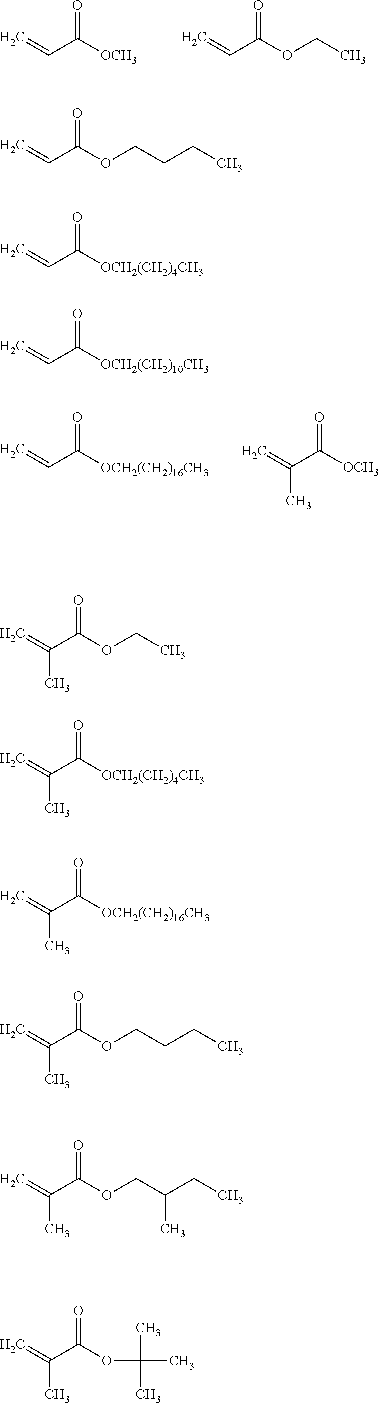

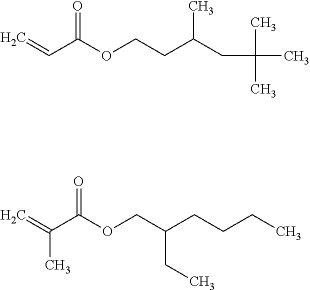

As to (C) acid monomer, it is selected from at least one member of the group of carboxylic acid, phosphate group, phosphonic acid group, phosphinic acid group, sulfate, sulfo group, and sulfino. Here are some examples listed below, but please be noted that they are not limitations of the present invention:
methacrylic acid, acrylic acid, 2-methyl acryloyloxy ethylsuccinic acid, 2-acryloyloxy ethylsuccinic acid, 2-methyl acryloyloxy ethyl benzenedicarboxylic acid, 2-acryloyloxy ethyl benzenedicarboxylic acid, 2-methyl acryloyloxy ethyl hexahydro benzenedicarboxylic acid, 2-acryloyloxy ethyl hexahydro benzenedicarboxylic acid, 2-acryloyloxy propyl benzenedicarboxylic acid, 2-acryloyloxy propyl hexahydro benzenedicarboxylic acid, 2-acryloyloxy propyl tetrahydro benzenedicarboxylic acid, itaconic acid, carboxyl ethyl acrylate, methyl acryloyloxy ethyl trimellitic acid, crotonic acid, 2-methyl acryloyloxy ethyl acid phosphate esters, 2-acryloyloxy ethyl acid phosphate esters, acid phosphoric acid methyl propyl acrylate, 3-chloride-acid phosphoric acid propyl methyl acrylate, vinyl phosphonic acid, acrylamide tert-butyl sulfonic acid, 2-acrylamide -2-methyl propane sulfonic acid, 2-sulfonic ethyl acrylate, 2-sulfonic ethyl methyl acrylate, 2-sulfonic propyl acrylate, 4-sulfonic phenyl acrylate, 2-hydroxyl-3-sulfonic propyl acrylate, 2-acrylamide propane sulfonic acid, 4-methyl acrylamide benzenesulfonic acid, p-vinyl benzenesulfinic acid, etc.

After the solvent-copolymer being diluted, silicon oil is optionally added thereinto to improve its lubricating effect, which enhances the releasing performance. The viscosity of said silicon oil at 25° C. is not specifically limited, and the silicon oil can be, more specifically, dimethyl silicone oil, methyl chloride silicon oil, methylphenyl silicone oil, organic denatured silicone oil, etc., but not limited as what we mentioned here. Below are more examples:

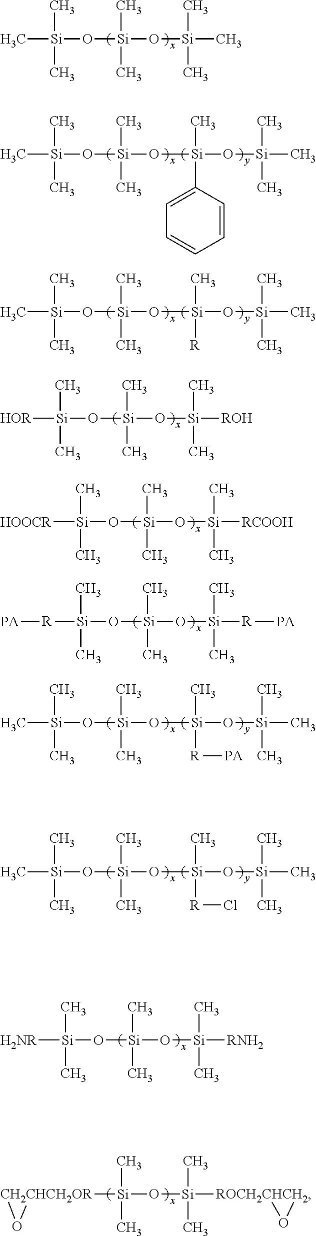

where
R is alkylidene radical which has one or more carbon atoms; PA is Polyoxyalkylene; x and y are integers, which are one or more.

### Fist Preferred Embodiment

Add 13.0 g of CF₃CF₂(CF₂CF₂)₂CH₂CH₂OCOCH═CH₂, 2.0 g of stearyl acrylate, 5 g of acrylic acid, and 30.0 g of isopropanol into a 250 ml glass reaction flask, and heat the flask to 60° C. After that, add 0.2 g of azobisisobutyronitrile HEPTANITRILE therein to perform polymerization reaction at 60° C. for 8 hours. According to analysis results of a gas chromatography, the conversion rate of the produced polymer is higher than 95%. The obtained fluorine-containing copolymer (20 g) is blended with silicon oil (20 g) and acetone (60 g), and then being tested with the following test method to evaluate releasing performance and longevity thereof. The test result is listed in Table 1.

<Test Method>
Dilute the solution of the first preferred embodiment until its solid contents becomes 1% by weight;
use a brush to coat the solution onto a stainless steel mold, of which diameter is 40 mm and thickness is 2 mm;
   have the mold air-dried at room temperature (25° C.) for an hour;
   evenly blend A agent (main agent) and B agent (hardener agent) of epoxy resin, and immediately pour into the mold with a pull ring placed at a center portion thereof, wherein the pull ring is for getting the molding out of the mold later;
   have the mold solidified at room temperature (25° C.) for half an hour; and
   judging the releasing performance and the longevity according to the feeling while pulling the pull ring with the below standard.

<Judging Standard of Releasing Performance>
(Scores)
5: The molding can be pulled out with almost no force.
4: Can be pulled out with slight force.
3: Can be pulled out with a moderate force.
2: The molding is hard to be pulled out even with a full force.
1: The molding is completely stuck in the mold, and is not able to be moved anyway.

Every time a molding is produced, we define the procedure as a molding operation. Longevity of a mold releasing agent is defined as the number of times that a molding can be pulled out of the mold with 3 or higher scores since the tested mold releasing agent is coated on the mold. The releasing performance drops sharply as the count of molding operation performed gets closer to the number of times presented by the longevity. For every mold releasing agent, before its count of molding operation performed actually reaches the number of times presented by the longevity, the releasing performance of each mold releasing agent is roughly the same. Therefore, the releasing performance of each mold releasing agents obtained in the preferred embodiments and the comparative examples listed in Table 1 and Table 2 is the highest score judged by the aforementioned standard in the test method, which is the score judged at the first time of performing a molding operation.

### Second Preferred Embodiment

Add 16.0 g of CF₃CF₂(CF₂CF₂)₂CH₂CH₂OCOCH═CH₂, 3.0 g of lauryl acrylate, 7.0 g of acrylic acid, and 30.0 g of isopropanol into the same kind of flask used in the first preferred embodiment, and heat the flask to 60° C. After that, add 0.2 g of azobisisobutyronitrile HEPTANITRILE therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Third Preferred Embodiment

Add 13.0 g of CF₃CF₂(CF₂CF₂)₃CH₂CH₂OCOCH═CH_{2, 2.5} g of stearyl acrylate, 5.0 g of acrylic acid, and 30.0 g of isopropanol into the same kind of flask used in the first preferred embodiment, and heat the flask to 60° C. After that, add 0.2 g of azobisisobutyronitrile HEPTANITRILE therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Fourth Preferred Embodiment

Add 12.0 g of CF₃CF₂(CF₂CF₂)ₙCH₂CH₂OCOCH═CH₂ (1.5% n=2, 65% n=3, 18% n=4, 3.5% n=5, 1.4% n=6), 1.0 g of lauryl acrylate, 5.0 g of acrylic acid, and 6.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Fifth Preferred Embodiment

Add 6.0 g of CF₃CF₂(CF₂CF₂)₂CH₂CH₂OCOCH═CH₂, 7.0 g of CF₃CF₂(CF₂CF₂)₃CH₂CH₂OCOCH═CH₂, 1.0 g of lauryl acrylate, 5.0 g of stearyl acrylate, 5.0 g of acrylic acid, and 60.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Sixth Preferred Embodiment

Add 11.0 g of CF₃CF₂(CF₂CF₂)₂CH₂CH₂OCOCH═CH₂, 1.0 g of lauryl acrylate, 2.0 g of acrylic acid, and 60.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Seventh Preferred Embodiment

Add 9.0 g of CF₃CF₂(CF₂CF₂)ₙCH₂CH₂OCOCH═CH₂(1.5% n=2, 65% n=3), 3.0 g of stearyl acrylate, 6.0 g of acrylic acid, and 60.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Comparative Example 1

Add 12.0 g of CF₃CF₂(CF₂CF₂)₂CH₂CH₂OCOCH═CH₂, 5.0 g of acrylic acid, and 30.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Comparative Example 2

Add 11.0 g of CF₃CF₂(CF₂CF₂)₂CH₂CH₂OCOCH═CH₂, 2.0 g of lauryl acrylate, 4.0 g of phosphoric acid Bis(2-methacryloyloxyethyl) hydrogen phosphate, and 30.0 g of isopropanol into the same kind of flask used in the first preferred embodiment, and heat the flask to 60° C. After that, add 0.2 g of azobisisobutyronitrile HEPTANITRILE therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Comparative Example 3

Add 14.0 g of CF₃CF₂(CF₂CF₃CF₂(CF₂CF₂)ₙCH₂CH₂OCOCH═CH₂ (1.5% n=2, 65% n=3, 18% n=4, 3.5% n=5, 1.4% n=6), 1.5 g of stearyl acrylate, 5.0 g of phosphoric acid Bis(2-methacryloyloxyethyl) hydrogen phosphate, and 6.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Comparative Example 4

Add 10.0 g of CF₃CF₂(CF₂CF₂)₃CH₂CH₂OCOCH═CH₂, 2.0 g of CF₃CF₂(CF₂CF₂)₄CH₂CH₂OCOCH═CH, 1.0 g of stearyl acrylate, 3.5 g of acrylic acid, and 60.0 g of isopropanol into the same kind of flask used in the first preferred embodiment, and heat the flask to 60° C. After that, add 0.2 g of azobisisobutyronitrile therein to perform polymerization reaction at 60° C. for 8 hours. According to analysis results of the gas chromatography, the conversion rate of the produced polymer is higher than 95%. The obtained fluorine-containing copolymer (20 g) is blended with silicon oil (20 g) and acetone (60 g), and then being tested with the aforementioned test method to evaluate releasing performance and longevity thereof. The test result is listed in Table 1.

### Eighth to Fourteenth Preferred Embodiments

Respectively add 2.0 g of ammonia into the polymer solutions obtained in the first to the seventh preferred embodiments, remove contained isopropanol by reduced pressure distillation, and then dilute the solution with water until the solid contents therein becomes 3% by weight. The releasing performance and the longevity of each mold releasing agent of these embodiments are tested with the aforementioned test method, and are listed in Table 2.

### Comparative Example 5-8

Respectively add 2.0 g of ammonia into the polymer solutions obtained in the comparative examples 1-4, remove contained isopropanol by reduced pressure distillation, and then dilute the solution with water until the solid contents therein becomes 3% by weight. The releasing performance and the longevity of each mold releasing agent of these embodiments are tested with the aforementioned test method, and are listed in Table 2.

TABLE 1
The releasing performance of the longevity of each
molding releasing agents obtained in the preferred
embodiments 1-7 and the comparative examples 1-4

| | The releasing performance | Longevity |
|---|---|---|
| | for the first time | (number of times) |
| 1^{st} Embodiment | 5 | 20 |
| 2^{nd} Embodiment | 3 | 14 |
| 3^{rd} Embodiment | 5 | 22 |
| 4^{th} Embodiment | 5 | 11 |
| 5th Embodiment | 4 | 18 |
| 6th Embodiment | 4 | 10 |
| 7th Embodiment | 4 | 13 |
| Comparative Example 1 | 3 | 9 |
| Comparative Example 2 | 5 | 11 |
| Comparative Example 3 | 4 | 7 |
| Comparative Example 4 | 4 | 12 |

TABLE 2
The releasing performance of the longevity of each
molding releasing agents obtained in the preferred
embodiments 8-14 and the comparative examples 5-8

| | The releasing performance | Longevity |
|---|---|---|
| | for the first time | (number of times) |
| 8^{th} Embodiment | 5 | 19 |
| 9^{th} Embodiment | 3 | 14 |
| 10^{th} Embodiment | 5 | 20 |
| 11^{th} Embodiment | 4 | 13 |
| 12^{th} Embodiment | 3 | 11 |
| 13^{th} Embodiment | 4 | 7 |
| 14^{th} Embodiment | 3 | 5 |
| Comparative Example 5 | 2 | 2 |
| Comparative Example 6 | 4 | 3 |
| Comparative Example 7 | 3 | 13 |
| Comparative Example 8 | 3 | 8 |

According to the aforementioned preferred embodiments and comparative examples, the mold releasing agent provided in the present invention, which is copolymerized with fluorine-containing monomer, acrylic ester monomer, and acid monomer, is able to replace the conventional compounds of long-chain perfluoroalkyl group to avoid the problem that the conventional compounds of long-chain perfluoroalkyl group would be degraded to PFOA in certain conditions, and the releasing performance and longevity is still comparable.

It must be pointed out that the embodiments described above are only some preferred embodiments of the present invention. All equivalent formulas which employ the concepts disclosed in this specification and the appended claims should fall within the scope of the present invention.

What is claimed is:

1. A mold releasing agent, comprising:
a fluorine-containing monomer;
an acrylic ester monomer; and
an acid monomer.

2. The mold releasing agent of claim 1, wherein the fluorine-containing monomer is represented by the general expression CH₂═C(—X)C(═O)—Y—Z—R_{f}, where
X is hydrogen atom, monovalent organic group, halogen atoms, linear or branched perfluoroalkyl with 1 to 21 carbon atoms, or cyano; Y is oxygen atom, sulfur atom, or secondary amine; Z is straight chain alkane, divalent organic group, aromatics or Cycloaliphatic of which carbon-number is 6 to 18, or aliphatic groups of which carbon-number is 1 to 10; R_{f} is linear or branched perfluoroalkyl of which carbon-number is 1 to 21.

3. The mold releasing agent of claim 1, wherein the acrylic ester monomer is represented by the general expression CH₂═CA₁COOA₂, where
A₁ is hydrogen atom, methyl, or halogen atoms other than fluorine atom; A₂ is CₙH₂ₙ₊₁ alkyl, wherein n is between 1 and 30.

4. The mold releasing agent of claim 3, wherein the acrylic ester monomer is selected from the group consisting of

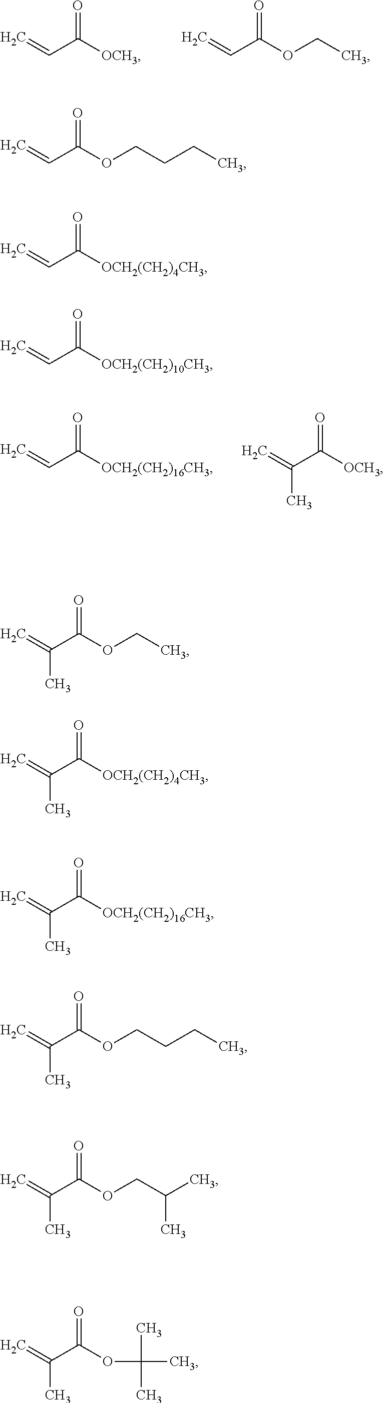

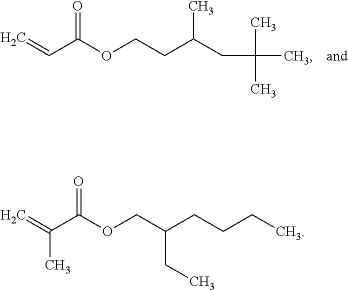

5. The mold releasing agent of claim 1, further comprising silicon oil.

6. The mold releasing agent of claim 5, wherein the silicon oil is selected from the group consisting of dimethyl silicone oil, methyl chloride silicon oil, methylphenyl silicone oil, and organic denatured silicone oil.

7. The mold releasing agent of claim 5, wherein the silicon oil is selected from the group consisting of 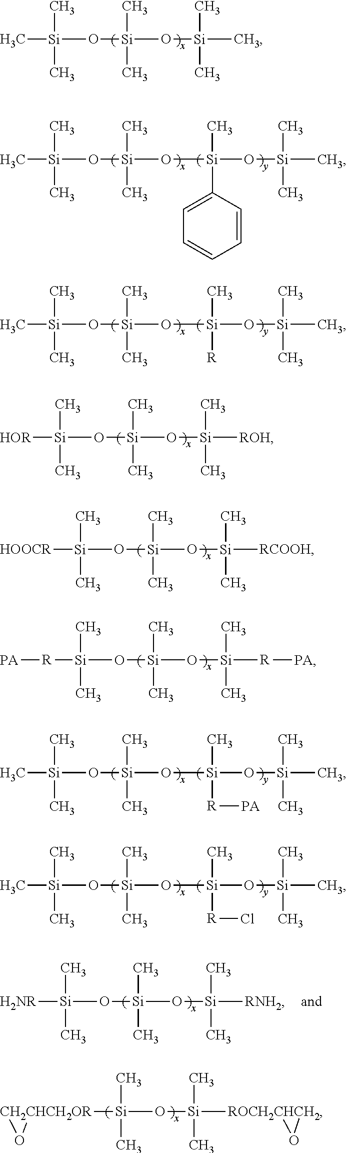
where
R is alkylidene radical which has one or more carbon atom; PA is Polyoxyalkylene; x and
y are integers, which are one or more.

8. The mold releasing agent of claim 1, wherein the acid monomer is selected from at least one member of the group consisting of carboxylic acid, phosphate group, phosphonic acid group, phosphinic acid group, sulfate, sulfo group, and sulfino.

9. The mold releasing agent of claim 1, further comprising Azobisisobutyronitrile or azobisisobutyronitrile HEPTANITRILE.

10. The mold releasing agent of claim 1, which is a solvent-copolymer.

11. The mold releasing agent of claim 10, wherein of which a solid content is 1% by weight.
